(19) United States
(12) Patent Application Publication
(10) Pub. No.: US 2024/0397887 A1
(43) Pub. Date: Dec. 5, 2024

(54) PLANT CULTIVATION SYSTEM AND METHODS OF MAKING AND USING THE SAME

(71) Applicant: Reid Barnett, Mount Olive, NC (US)

(72) Inventor: Reid Barnett, Mount Olive, NC (US)

(21) Appl. No.: 18/655,461

(22) Filed: May 6, 2024

Related U.S. Application Data
(60) Provisional application No. 63/470,260, filed on Jun. 1, 2023.

(51) Int. Cl. A01G 31/02

(52) U.S. Cl. CPC A01G 31/02; A01G 24/15; A01G 24/44; A01G 24/48

(57) ABSTRACT

The invention is a plant cultivation system for growing plants in or on a body of water. The system includes a plant support that is at least partially buoyant in the water or sinks below a surface of the water. The system further includes a plurality of plant seeds positioned on a top surface of the support. The seeds germinate and grow into plants within the structure, using the body of water as a nutrient source. Advantageously, as the plants grow, they remove pollutants from the water, such as nitrogen and phosphorous. As a result, nutrient pollution from the water is reduced and cultural eutrophication is reversed, thereby preventing deadly algal blooms, and increasing the health of the aquatic ecosystem.

### FIELD OF THE INVENTION

The presently disclosed subject matter is directed to a plant cultivation system and to methods of making and using the disclosed system.

### BACKGROUND OF THE INVENTION

Water pollution has become a serious problem in ponds and lakes in a number of parks, golf courses, and the like. In addition, industrial and domestic wastewater discharge has similarly given rise to water pollution in rivers, lakes, and streams. Water pollution not only ruins the appearance of natural environments, but also kills plants and animals and produces bad odors. By way of illustration, rapid increases in plant growth brought about by excessive nutrient deposition (eutrophication) in bodies of water through runoff of soil fertilizers and discharge of municipal or industrial wastes can result in “blooms” of aquatic algae and a rapid disruption of the normal trophic balance between algae and algal feeders. Although algae are common inhabitants of surface waters, excessive quantities can be troublesome to both wildlife and to humans. Because increased amounts of mineral wastes are currently being discharged into open bodies of water where they can be used as food by algae, many inland ponds and lakes are being smothered by algal population explosions. Such increases in algae do not pass normally into the food chain as fish and other lower forms of animal life cannot feed on algae. In the case of water supplies designed for human consumption, excessive amounts of algae can produce disagreeable odors and “fishy” tastes as well as clogging of filtration machinery. In response, there have been efforts to remediate water pollution using various types of purification equipment and materials. However, the noted mechanical tools are expensive, difficult to maintain, and are expensive to run (e.g., requiring replacement of filters and the like). Further, each prior art solution produces only a temporary effect. It would therefore be desirable to provide a plant cultivation system that overcomes the shortcomings of prior art solutions that address the issues of algal bloom and water pollution.

### SUMMARY OF THE INVENTION

In some embodiments, the presently disclosed subject matter is directed to a buoyant plant cultivation system. Specifically, the system comprises a support comprising one or more buoyant materials. The system also includes a plurality of plant seeds positioned on the top face of the support. The plant seeds are configured to germinate and grow such that plant roots extend into an interior of the support and plant leaves and plant stems grow above the top face of the support. The support is configured to float on a body of water.

In some embodiments, the support is constructed from kapok fibers, open-celled foam, cork, perlite, vermiculite, or combinations thereof.

In some embodiments, the support further includes one or more polymeric materials selected from polyethylene, polypropylene, or both.

In some embodiments, the support is permeable to air and water.

In some embodiments, the support is constructed from one or more biodegradable materials selected from fabric, felt, cork, fiber, polyester, polyolefin, polyamide, or combinations thereof.

In some embodiments, the support is about 100% biodegradable.

In some embodiments, the support has a length, width, or both of about 1-100 feet and a thickness of about 0.5-5 inches.

In some embodiments, the system is self-floating (e.g., does not require any additional floatation elements to float on a surface of a body of water).

In some embodiments, the presently disclosed subject matter is directed to a method of reducing pollutants from a body of water that includes pollutants. Particularly, the method comprises positioning the disclosed floating plant cultivation system into a body of water, wherein the support floats on a surface of the body of water, and wherein the water enters the interior of the support through capillary action. The method includes germinating the seeds such that the seeds grow into plants with roots that extend into the interior of the support and plant leaves and stem grow above the support. As the plants grow, the plants absorb the pollutants from the water. The amount of pollutants in the body of water are thereby reduced.

In some embodiments, the presently disclosed subject matter is directed to a method of reducing the amount of carbon dioxide in an environment. Specifically, the method comprises positioning the disclosed floating plant cultivation system into a body of water, wherein the support floats on a surface of the body of water, and wherein the water enters the interior of the support through capillary action. The method includes germinating the seeds such that the seeds grow into a plant with roots that extend into the interior of the support and plant leaves and stems grow above the support. As the plants grow, the plants absorb carbon dioxide from the environment and the amount of carbon dioxide is thereby reduced.

In some embodiments, the presently disclosed subject matter is directed to a method of reducing algal bloom in a body of water. Specifically, the method comprises positioning the disclosed floating plant cultivation system into a body of water, wherein the support floats on a surface of the body of water, and wherein the water enters the interior of the support through capillary action. The method includes germinating the seeds such that the seeds grow into a plant with roots that extend into the interior of the support and plant leaves and stems grow above the support. As the plants grow, the plants absorb nutrients from the body of water and the amount of nutrients within the body of water is thereby reduced and algal bloom is reduced.

In some embodiments, the presently disclosed subject matter is directed to a plant cultivation system. Specifically, the system comprises a support constructed from one or more polymeric materials. The system includes a plurality of plant seeds positioned on a top face of the support, wherein the plant seeds are configured to germinate and grow such that plant roots extend into an interior of the support and plant leaves and plant stems grow above the top face of the support. The support is configured to float on a body of water for a predetermined amount of time, and then sinks to the bottom of the body of water.

In some embodiments, the support floats with the current or is anchored at a predetermined location.

In some embodiments, the polymeric materials are selected from polyethylene, polypropylene, or combinations thereof.

In some embodiments, the predetermined amount of time is about 1-4 months.

In some embodiments, the presently disclosed subject matter is directed to a carbon sequestration system. The system comprises a non-buoyant support constructed from one or more non-biodegradable polymeric materials. The system includes one or more floatation devices configured to float on the surface of a body of water, each floatation device attached to the non-buoyant support positioned beneath the surface of the body of water. The support is positioned about 10-30 feet below the surface of the body of water. “Non-buoyant” refers to the characteristic of sinking in a liquid. Thus, a non-buoyant material has a density that is greater than the density of water 25.

In some embodiments, the carbon sequestration system includes a plurality of aquatic plants positioned on a top face or within an interior of the support, wherein the aquatic plants are configured to grow on and within the support.

In some embodiments, the aquatic plants are selected from sea grasses, seaweed, kelp, or combinations thereof.

In some embodiments, the support has a density that is greater than the density of the body of water.

In some embodiments, the presently disclosed subject matter is directed to a method of sequestering carbon from an environment. Particularly, the method comprises positioning the carbon sequestration system into the body of water, wherein the support sinks beneath a surface of the water and the one or more floatation devices float on the water and retain the support a desired depth within the water. The method includes positioning aquatic plants within the interior of the support, on the surface of the support or both. As the plants grow, the plants absorb carbon dioxide from the body of water and the carbon is thereby sequestered from the environment (e.g., from the air, water, or both).

### BRIEF DESCRIPTION OF THE DRAWINGS

FIG. 1a is a cross-sectional view of a buoyant plant cultivation system in accordance with some embodiments of the presently disclosed subject matter.

FIG. 1b is a cross-sectional view of a buoyant plant cultivation system comprising plants in accordance with some embodiments of the presently disclosed subject matter.

FIG. 2a is a top plan view of a cultivation system support in accordance with some embodiments of the presently disclosed subject matter.

FIG. 2b is a cross-sectional view of a cultivation system support in accordance with some embodiments of the presently disclosed subject matter.

FIG. 2c is a perspective view of a rolled cultivation support in accordance with some embodiments of the presently disclosed subject matter.

FIG. 2d is a perspective view of a folded cultivation support in accordance with some embodiments of the presently disclosed subject matter.

FIG. 3 is a cross-sectional view of a plant cultivation system comprising plants in accordance with some embodiments of the presently disclosed subject matter.

FIG. 4 is a schematic illustrating one embodiment of using a cultivation support system in accordance with some embodiments of the presently disclosed subject matter.

FIG. 5 is a sectional view of a cultivation support system comprising a growing plant in accordance with some embodiments of the presently disclosed subject matter.

FIG. 6 is a schematic illustrating one embodiment of using a cultivation support system in accordance with some embodiments of the presently disclosed subject matter.

FIG. 7 is a cross-sectional view of a cultivation support suspended below the surface of the water in accordance with some embodiments of the presently disclosed subject matter.

### DETAILED DESCRIPTION OF THE INVENTION

For the purpose of promoting an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e., at least one) of the grammatical object of the article. By way of example, “an element” means at least one element and can include more than one element. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about.” Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments+/−20%, in some embodiments+/−10%, in some embodiments+/−5%, in some embodiments+/−1%, in some embodiments+/−0.5%, and in some embodiments +/−0.1%, from the specified amount, as such variations are appropriate in the disclosed packages and methods. Thus, the term “about” is used to provide flexibility to a numerical range endpoint by providing that a given value may be “slightly above” or “slightly below” the endpoint without affecting the desired result.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

All methods described herein can be performed in any suitable order unless otherwise indicated herein or otherwise clearly contradicted by context. The use of any and all examples, or exemplary language (e.g., “such as”) provided herein, is intended merely to better illuminate the invention, and does not pose a limitation on the scope of the invention unless otherwise claimed. No language in the specification should be construed as indicating any unclaimed element as essential to the practice of the invention.

Unless otherwise defined, all technical terms used herein have the same meaning as commonly understood by one of ordinary skill in the art to which this disclosure belongs.

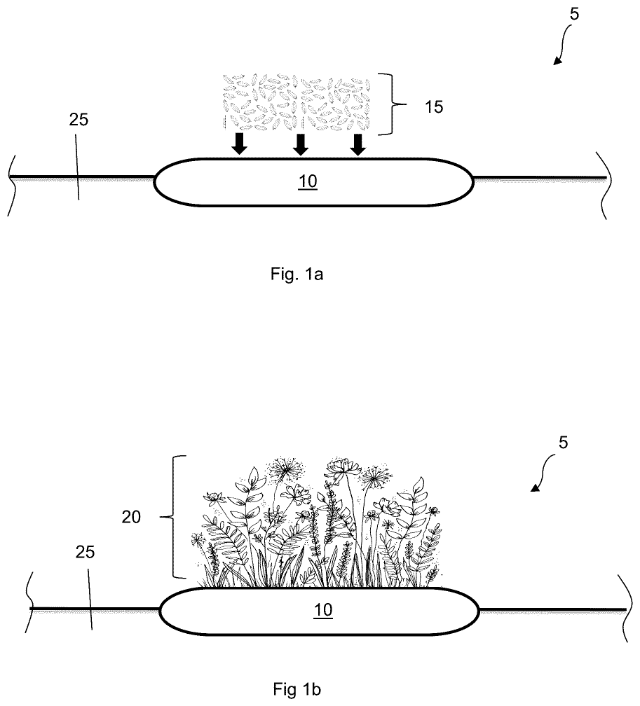

The presently disclosed subject matter is directed to plant cultivation system 5 for growing plants in a body of water. The term “plant cultivation system” refers to a system that supports the growth of one or more plants. As illustrated in FIGS. 1a and 1b, the system includes plant support 10 that is at least partially buoyant in the water in some embodiments. For example, a portion of the support can float above the surface of the water, while a lower region of the support can be submerged below the water line. However, the disclosed system can also be fully submerged beneath the water as discussed below.

The system includes a plurality of plant seeds 15 positioned on a top and/or outer surface of the support. The seeds germinate and grow into plants 20 within the structure, using the body of water as a nutrient source (e.g., as a water source and as a source of substances used by the plant to survive, grow, and reproduce). Advantageously, as the plants grow, they remove pollutants from water 25, such as nitrogen and phosphorous. As a result, nutrient pollution from the water is reduced and cultural eutrophication is reversed, thereby preventing deadly algal blooms, and increasing the health of the aquatic ecosystem. “Eutrophication” refers to the accumulation of nutrients in a body of water, resulting in an increased growth of microorganisms that can deplete the water of oxygen. Specifically, nutrient pollution can cause algal blooms and bacterial growth, resulting in the depletion of dissolved oxygen in water and causing substantial environmental degradation. The growth of plants 20 within the support require large quantities of carbon dioxide. As such, the system is carbon negative and advantageously sequesters carbon from the atmosphere.

As noted above, system 5 includes support 10 that acts as a substrate for growing plants 20. Support 10 can be constructed from one or more buoyant materials. The term “buoyant” refers to the characteristic of being capable of floating at the surface of a body of water into which it is placed. Thus, a buoyant material have greater specific gravity and lower density than that of the surrounding water source. The buoyant support can act as a floating island that supports the growth of seeds and plants, as discussed in more detail below. Advantageously, the support does not require additional floats or other external features to keep the structure above the top surface of the water (e.g., it is self-floating) in some embodiments.

In some embodiments, about half of the support is positioned above the water when in use, while a lower half of the support remains submerged beneath water 25, as shown in FIGS. 1a and 1b. However, system 5 is not limited and can include embodiments where about 10-90 percent (e.g., at least/no more than about 10, 15, 20, 25, 30, 35, 40, 45, 50, 55, 60, 65, 70, 75, 80, 85, or 90 percent) of the support is positioned (e.g., floating) above the water line, while about 90-10 percent (e.g., at least/no more than about 90, 85, 80, 75, 70, 65, 60, 55, 50, 45, 40, 35, 30, 25, 20, 15, or 10 percent) of the support is submerged beneath the water line. The term “water line” refers to the height of a body of water.

In some embodiments, the support can include a single nonwoven sheet constructed from one or more buoyant materials. Suitable buoyant materials can include (but are not limited to) plant fibers (e.g., kapok fibers), cotton, open-celled foam, cork, perlite, vermiculite, or combinations thereof. For example, kapok fibers may be used to enhance the buoyance of support 10. “Kapok” refers to a cotton-like plant obtained from the seed pods of a number of trees in the Malvaceae family, commonly used for stuffing mattresses and pillows for padding and cushioning. Suitable non-limiting kapok trees and plants include (but are not limited to) trees and shrubs of the Bombax genus (e.g., Bombax ceiba), Ceiba pentandra, Calotropis procera, Cochlospermum fraseri, Cochlospermum gillivrael, Cochlospermum gregoriii.

“Cotton” refers to a soft, fluffy staple fiber that grows in a boll, or protective case, around the seeds of the cotton plants of the genus Gossypium in the mallow family Malvaceae. The fiber is almost pure cellulose, and can contain minor percentages of waxes, fats, pectins, and water. “Open celled foam” refers to a foam including a multiplicity of cells, having an open-cell content of at least about 50%, measured using ASTM D2856, Method C (incorporated by reference herein). “Cork” refers to the phellem layer of bark tissue that is harvested for commercial use primarily from Quercus suber (the cork oak), native to southwest Europe and northwest Africa. Cork is composed of suberin, a hydrophobic substance. “Perlite” is an amorphous volcanic glass that has a relatively high water content, typically formed by the hydration of obsidian. Vermiculite is a hydrous phyllosilicate mineral that undergoes significant expansion when heated. Vermiculite forms by the weathering or hydrothermal alteration of biotite or phlogopite.

In some embodiments, a blend or two or more materials can be used to construct support 10. For example, a blend of kapok fibers (allowing for floatation) and one or more polymeric materials (e.g., a moiety comprising one or more polymers) may be suitable for use. The polymeric material can include polylactic acid (PLA), polyvinyl alcohol, polyhydroxyalkanoates, polyesters, polybutylene adipate terephthalate, polyglycolic acid, polycaproic acid, polybutyric acid, polyamide, polycarbonate, polystyrene, polymethyl methacrylate, acrylonitrile butadiene styrene copolymer, acrylonitrile styrene copolymer, polyolefin, polyoxymethylene, polysulfone, polyphenylene ether, polyphenylene sulphide, polyphenylene oxide, liquid-crystalline polymers, polyether ketone, polyether ether ketone, polyimide, polyamide imide, polyester imide, polyether amide, polyester amide, polyether ester amide, polyurethane, polysiloxane, polyacrylate, polymethacrylate or combinations thereof. Thus, any polymeric or thermoplastic material can be used. “Thermoplastic” includes any plastic polymer material that becomes pliable or moldable at a certain elevated temperature and solidifies upon cooling. In some embodiments, the polymeric and/or thermoplastic materials can be biodegradable (collagen, polyhydroalkanoates, polyesters, starch, polyanhydrides, polycaprolactone, chitosan, polyphophazene, elastin, polycarbonate, polylactic acid, polyphosphoesters, polyglycolide, alginate, etc.).

When a blend of materials are used to construct the support, the fibrous material can make up about 0-100 weight percent of the blend (e.g., at least/no more than about 0, 1, 5, 10, 15, 20, 25, 30, 35, 40, 45, 50, 55, 60, 65, 70, 75, 80, 85, 90, 95, 99, or 100 weight percent), and the polymeric material can make up about 100-0 weight percent of the blend (e.g., at least/no more than about 100, 99, 95, 90, 85, 80, 75, 70, 65, 60, 55, 50, 45, 40, 35, 30, 25, 20, 15, 10, 5, 1, or 0 weight percent).

In some embodiments, the materials used to construct the support are highly permeable to both air and water. In this way, the seeds and plant roots have access to both air and water 25 to promote growth. The term “permeable” refers to a material that allows exchange of one or more gases and/or fluids from one side of the material to the other. Thus, a gas permeable material allows for the exchange of gases from one side of the material to the outer (e.g., the outside environment to the interior of support 10). A water permeable material includes a material with pores, openings, and/or interconnected void space that permits liquid (e.g., water) to pass through its thickness in the absence of forcing pressure.

In some embodiments, the materials used to construct the support can include one or more biodegradable materials. The term “biodegradable” refers to a material that has a measurable half-life in a biological environment. Suitable biodegradable materials can include (but are not limited to) fabric, felt, cork, fiber, polyester, polyolefin, polyamide, and combinations thereof. In some embodiments, support 10 is about 100% biodegradable. In other embodiments, the support is about 50-99.9% biodegradable (e.g., at least/no more than about 50, 60, 70, 80, 90, 99, or 99.9% biodegradable). In still other embodiments, the support is nonbiodegradable (e.g., does not biodegrade).

In some embodiments, system 5 can be compostable. For example, the system can be sold as compost to lock away sequestered carbon in the soil, thereby replacing synthetic fertilizers. The term “compostable” refers to a material capable of decomposing into harmless natural products under conditions of natural composition (e.g., through the action of naturally occurring microorganisms).

Any method can be used to construct the support. For example, polymeric fibers can be hydroentangled over kapok after it has been lightly carded in some embodiments. Hydroentangling is a bonding process for wet and/or dry fibrous webs made by either carding, airlaying, or wet laying to produce a nonwoven bonded material. Hydroentangling can include fine, high pressure jets of water that penetrate the web, hit a conveyor belt, and bounce back, causing the fibers to entangle. Carding is a mechanical process that disentangles, cleans, and intermixes fibers to produce a continuous web by passing the fibers between differentially moving surfaces covered with card clothing (a firm flexible material embedded with metal pins). Locks and unorganized clumps of fiber are broken up and then individual fibers are aligned to be parallel with each other.

In airlaying, bundles of small fibers (e.g., lengths ranging from about 1 to about 19 millimeters) are separated, entrained in an air supply, and then deposited onto a forming screen, usually with the assistance of a vacuum supply. The randomly deposited fibers then are bonded to one another using, for example, hot air when a thermal binder is used, water compaction, or a spray adhesive (latex, for example).

Water laying is a process in which bundles of small fibers having typical lengths ranging from about 3 to about 52 millimeters (mm) are separated and entrained in a liquid supply (e.g., water) and then deposited onto a forming screen, usually with the assistance of a vacuum supply. The randomly deposited fibers may by further entangled (e.g., hydro-entangled), or may be bonded to one another using, for example, thermal point bonding, autogenous bonding, hot air bonding, ultrasonic bonding, needle punching, calendaring, application of a spray adhesive, and the like. An exemplary wet-laying and bonding process is taught in, for example, U.S. Pat. No. 5,167,765 (Nielsen et al), incorporated by reference herein. Exemplary bonding processes are also disclosed in, for example, U.S. Pat. No. 9,139,940 (Berrigan et al), incorporated by reference herein.

In other embodiments, the fibers can be mixed thoroughly, and heat applied to create a matrix, blending the materials (e.g., kapok and/or polymeric material) together. It should be appreciated that any of a wide variety of methods can be used to construct support 10.

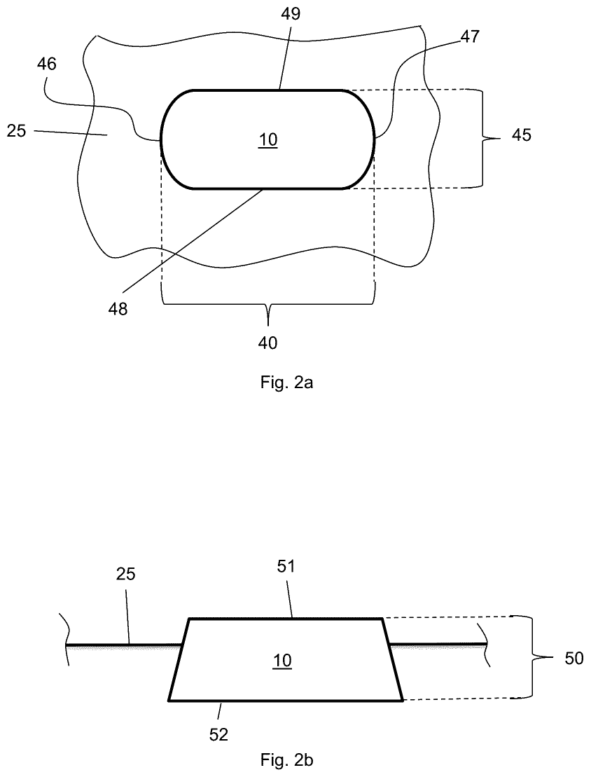

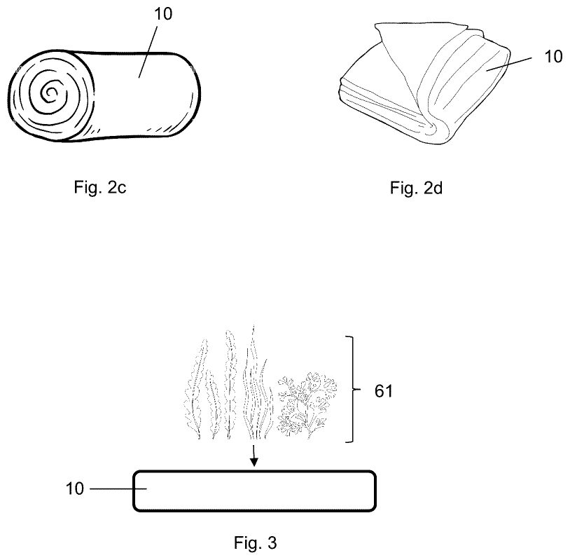

The support can be constructed in any suitable size or shape. To this end, the support can have length 40 and/or width 45 of about 1-100 feet (e.g., at least/no more than about 1, 10, 20, 30, 40, 50, 60, 70, 80, 90, or 100 feet). The term “length” refers to the longest horizontal distance of the support, as shown in FIG. 2a. In some embodiments, the length can be the distance from the left-most edge 46 to the right-most edge 47 of the support. The term “width” refers to the longest vertical distance of the support. In some embodiments, the width can be the distance between the front 48 of the support to the opposed rear face 49. The support can also include thickness 50 of about 1 inch (e.g., at least/no more than about 0.1, 0.25, 0.5, 0.75, 1, 1.5, 2, 2.5, 3, 3.5, 4, 4.5, or 5 inches). The term “thickness” refers to the distance between the top and bottom faces 51, 52 of the support, as shown in FIG. 2b. It should be appreciated that the ranges given for the length, width, and thickness are not limiting and the support can have any desired dimensions.

Support 10 can be configured in any desired shape, such as rounded, square, rectangular, trapezoidal, abstract, freeform, and the like. It should be appreciated that any shape can be used. In some embodiments, the support can be configured in a substantially flat sheet that is rolled or folded for storage or until needed, as shown in FIGS. 2c and 2d, respectively.

As noted above, the system also includes plant seeds 15 deposited on top surface 51 of support 10. The term “plant seed” includes any type of plant that can be sown. Thus, suitable plants seeds can include (but are not limited to) flower seeds, grass seeds, legume and other pasture plant seeds, crop seeds, tree seeds, weed seeds, and the like. Any quantity of seeds can be used. The seeds can be directly dispersed along the top surface of the support using any conventional method, such as spraying. In other embodiments, a mixture of seeds, adhesive, and/or nutrients can be added to the top surface of the support. Water is delivered to seeds 15 via capillary action through the support to promote germination. The term “germination” refers to the sprouting of a seedling from a seed as it grows into a mature plant. “Capillary action” refers to the process of a liquid flowing in a narrow space in opposition to or at least without the assistance of any external forces like gravity. Capillary action occurs because of intermolecular forces between the liquid and surrounding solid surfaces. If the diameter of the tube is sufficiently small, then the combination of surface tension (which is caused by cohesion within the liquid) and adhesive forces between the liquid and container wall act to propel the liquid.

As described below, the support can also be seeded by gathering plants from natural beds (e.g., seaweed, seagrasses, kelp) and attaching them to support 10. For example, FIG. 3 illustrates seaweed 61 being attached to a surface and/or interior of support 10. The plants or seedlings are attached to the support using lines, weaving, or any other attachment mechanism. In this way, the seaweed is attached to the support, submerged beneath water 25, and allowed to grow and reproduce.

In use, system 5 can grow terrestrial plants (plants that grow typically/traditionally on land), aquatic plants (plants that grow traditionally/typically in water), and biofilm in a body of water (e.g., fresh water and/or saltwater). The term “biofilm” refers to a syntrophic community of microorganisms in which cells stick to each other and often also to a surface. The adherent biofilm cells become embedded within a slimy extracellular matrix that includes extracellular polymeric substances (EPS). Specifically, the cells within the biofilm produce the EPS components, which are typically a polymeric combination of extracellular polysaccharides, proteins, lipids, and DNA. The plants and biofilm create a symbiotic system that removes large amounts of nutrient pollution from the environment and carbon dioxide from the atmosphere. Due to composition of support 10, the system can be composted after use to create healthy soil and/or fertilizer in some embodiments.

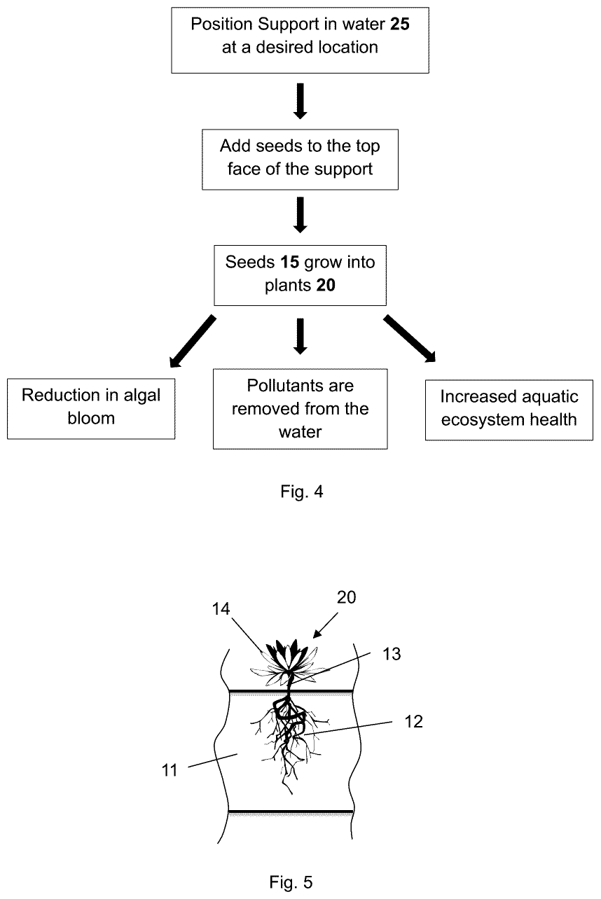

In some embodiments, the support is placed in body of water 25, which can be a natural pond, artificial pond, aquaculture pond, fishery, delta, bay, sump pond, aquifer, water reclamation facility, golf course pond, bog, lake, river, or any other body of water to improve water quality and enhance the quality of plant/animal life, as set forth in the schematic of FIG. 4. Specifically, the body of water can be freshwater or saltwater. “Freshwater” includes any body of water that includes low levels of dissolved salts (e.g., less than 500 parts per million of dissolved salts). Thus, freshwater sources of water include wetlands, ponds, lakes, rivers, swamps, springs, bogs, streams, groundwater aquifers, subterranean rivers/lakes. “Saltwater” refers to a body of water that includes high levels of dissolved salts (e.g., 500 parts per million of dissolved salts or more). Saltwater sources can include seawater and brackish water (water with more salinity than freshwater but not as much as saltwater).

Advantageously, installation of the system does not require the draining of water, construction of a submerged substructure, fitting or alteration of a pond liner, or disturbance of existing flora or fauna. Rather, the support is simply positioned on the top surface of water 25 and allowed to float with the current in some embodiments. Alternatively, the support can be anchored into place at a desired location. For example, the support can be tied or otherwise retained to an object at a set location below, above, or out of the water. By virtue of its design, the system results in only minimal water displacement, which allows the pond or other water body to retain carrying capacity and does not adversely affect the health of the water body.

Optionally, after the system has been deposited into water 25, the buoyancy of the support can be adjusted by adding or removing materials from interior layer 35 as needed.

As shown in FIG. 5, as seeds 15 germinate into plants 20 and grow, the plant roots 12 are supported within support interior 11. In this way, the plants have structural support and are able to receive nutrients from the water used for growth. The plant leaves 13 and stem 14 also grow upwards from the top face of the support and have exposure to sunlight. Thus, within the interior layer, the roots of living plants are supported in a substrate that can include other living roots, dead roots, and partially decomposed organic materials derived from dead plants and microbes. As used herein, the term “plant” refers to any plants amenable to growth on the floating system, including angiosperms, gymnosperms, monocotyledons and dicotyledons.

Beneficially, as plants 20 grow, they remove pollutants from water 25. For example, nitrogen and phosphorous can be removed from the water. In this way, system 5 functions to ameliorate nutrient pollution from water 25. The term “nutrient pollution” refers to a form of water pollution in which the water becomes contaminated by excessive inputs of nutrients, typically through farm and field surface runoff, septic tank and feedlot discharges, and emissions from combustion. As a result of the reduction in nutrient pollution, cultural eutrophication is reduced and/or reversed, preventing the incidence of algal blooms, and increasing the health of aquatic ecosystems.

In addition, the growth of plants 20 on support 10 consumes large quantities of carbon dioxide, making the disclosed technology carbon negative and provides a way to sequester carbon from the atmosphere. Stated another way, the system can be used as to effectively combat carbon dioxide in the atmosphere.

The rate of nutrient removal can be dependent upon the flow rate of water 25. In some embodiments, the water can be pumped and/or sprayed over the system, thereby increasing the rate at which water nutrients are removed. Optionally, a wind-powered, wave-powered, or solar-powered pump or similar mechanism can be added to increase the rate of water flow through the system.

In some embodiments, system 5 can be configured as a permanent installation that seeds any desired aquatic ecosystem with minimal effort. Specifically, support 5 can be installed at a desired location where it remains until a user removes the support.

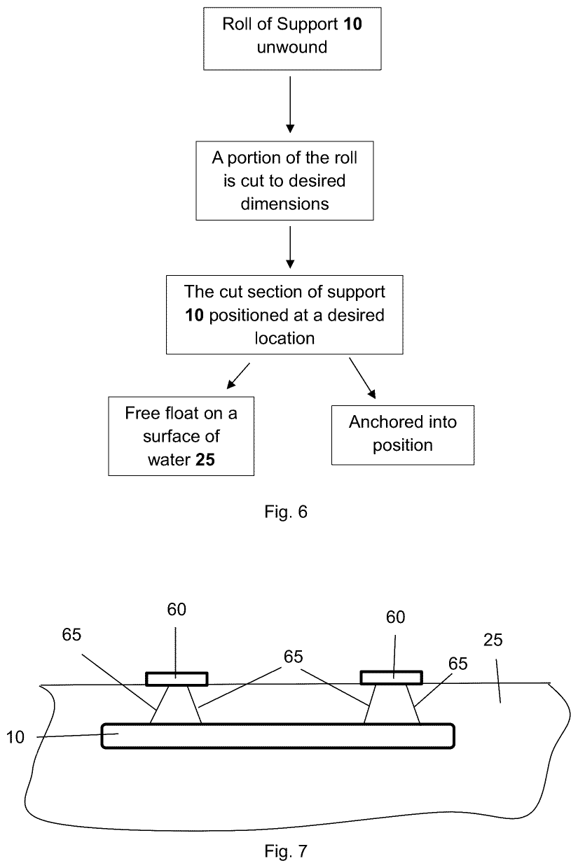

In use, support 10 can be installed by a minimum of two people by simply unrolling a section of material needed. For example, the support can be cut from a larger roll in a desired size and positioned where desired in a body of water (freshwater or saltwater as noted above). The support can be anchored into a desired position or can be allowed to free float on the surface of water 25, as noted in the schematic of FIG. 6. Conventional methods of installing similar systems require the existing environment to be completely destroyed and/or requires the use of heavy and expensive machinery.

Any of a wide variety of mechanisms can be used to anchor the cut section of support 10 into place. For example, support 10 can be maintained in a location through the use of physical constraints such as ties, clips, and similar elements.

In embodiments that include letting the cut section of support 10 free float on a surface of water 25, the cut section is simply released and travels along with the current.

No set location is retained by the support.

Seeds can be added prior to and/or after the support has been added to the water. In some embodiments, the seeds are imbedded in support 10 (e.g., at a manufacturing facility) prior to installation in the water. Water 25 serves as a nutrient source for the seeds, allowing growth into plants as discussed above.

In some embodiments, system 5 can be used to bolster a shoreline. For example, the support can be anchored or retained at a desired location, adjacent to a shoreline. As a result, the system can prevent erosion by serving as an energy-absorbing damper to waves and/or water.

Support 10 can include any combination of polymeric materials (e.g., no kapok or other natural fibers are required) in some embodiments. For example, the support can include polypropylene, polyethylene, or combinations thereof. Thus, the support can comprise about 100 weight percent polypropylene or about 100 weight percent polyethylene. In other embodiments, the support can include a blend of polymeric materials such as about 20-80 weight percent polypropylene (e.g., 20, 25, 30, 35, 40, 45, 50, 55, 60, 65, 70, 75, or 80 weight percent) and about 80-20 weight percent polyethylene (e.g., 80, 75, 70, 65, 60, 55, 50, 45, 40, 35, 30, 25, or 20 weight percent). Any desired polymeric materials or blends can be used. Advantageously, the polymeric materials have an initial degree of buoyance and can be modified to degrade naturally. The natural buoyant characteristic of the support allows for ease of installation on a body of water and encourages development of biofilm at the high oxygen environment on the surface of the water before the accrued growth is transplanted to the bottom of the body of water.

In use, the support is installed on a target body of water 25 and allowed to either free float or is retained at a desired location. The support initially floats on the surface of the water, but as biofilm and the plants grow on the surface of the support, the support will sink to the floor of the body of water (e.g., no longer floats). In some embodiments, the support can float on the surface of the water for about 1, 2, 3, 4, 5, or 6 months and then sinks to the bottom of the water as the materials of the support naturally biodegrade. In some embodiments, the system can be configured as an artificial aquatic carbon sequestration system. Specifically, support 10 can be configured as a platform seeded with seagrasses, seaweed, and/or kelp. The support can be positioned at an optimal depth below the waterline (e.g., about 10-30 feet under the surface of water 25), allowing the plants to grow and sequester carbon from the environment on a large scale.

The structure of support 10 can be configured to recruit additional plants to grow on the structure as the plants reproduce. For example, support 10 can include any combination of polymeric materials (e.g., no kapok or other natural fibers are required), such as polypropylene, polyethylene, or combinations thereof. In some embodiments, the materials used to construct the support are non-biodegradable (e.g., do not break down or degrade during use). In this way, the support can be permanent and used for any length of time.

Support 10 can be constructed with a density greater than water 25 such that the support sinks below the surface of the water. To this end, the support can have a density of greater than 1 g/mL (the approximate density of water). The density of the support can be about 1.1 g/mL, 1.25 g/mL, 1.5 g/mL, 1.75 g/mL, 2 g/mL, 2.25 g/mL, 2.5 g/mL, 2.75 g/mL, or more.

To keep support 10 at a desired depth beneath the surface of water 25, an additional buoyant structure on the surface of the water may be required. For example, standard floatation devices 60 can be positioned on the top surface of water 25 and the support 10 adhered to the flotation at a desired distance from the waterline, as shown in FIG. 7. Any material that floats on the surface of the water can be used as floatation devices 60 (e.g. air-filled elements, cork, foam, etc.). The floatation devices can be connected to support 10 via one or more attachments 65 that retain the support at a desired depth below the water surface. The attachments can be any element such as cords, stainless steel wire, rope, etc.

The support can be seeded with seagrasses, seaweed, kelp, or any other desired plant suitable for growth beneath the surface of water 25. “Seeding” refers to the process of adding seeds, seedlings, or plants to the exterior and/or interior of the support. The plants use nutrients from the water to grow on the support. Seagrasses include any flowering plants that grow in marine environments. There are about 60 species of fully marine seagrasses that belong to four families (Posidoniaceae, Zosteraceae, Hydrocharitaceae and Cymodoceaceae), all in the order Alismatales (in the clade of monocotyledons). Seaweed (or microalgae) includes thousands of species of macroscopic, multicellular, marine algae. For example, seaweed includes types of Rhodophyta (red), Phaeophyta (brown) and Chlorophyta (green) macroalgae. Kelp is a type of large brown algae or seaweed that make up the order Laminariales. Kelp is a stramenopile, a group containing many protists. The support can recruit additional plants to grow on the structure as they reproduce.

The system can sequester carbon from the environment on a large scale. Specifically, carbon sequestration is the process of storing carbon in a carbon pool. It plays a crucial role in mitigating climate change by reducing the amount of carbon dioxide in the atmosphere. Biologic carbon sequestration is a naturally occurring process as part of the carbon cycle. Carbon dioxide is naturally captured from the atmosphere through biological, chemical, and physical processes. These processes can be accelerated through changes in land use and agricultural practices (“carbon farming”). Artificial processes have also been devised to produce similar effects, using technology to capture and sequester carbon dioxide produced from human activities underground or under the seabed. Forests, kelp beds, and other forms of plant life absorb carbon dioxide from the air as they grow and bind it into biomass. Because the support can be permanent, the carbon sequestration can continue for an extended period of time (several months or years).

The disclosed system offers many advantages. For example, growth of plants 20 within the support has been shown to remove nutrient pollution from water 25.

System 5 is relatively inexpensive to make, using conventional materials and requiring minimal construction or maintenance costs.

System 5 (at least in part due to the removal of nitrogen, phosphorus, and other nutrients from water 25), can effectively reduce and reverse cultural eutrophication. As a result, algal blooms are prevented, and the health of aquatic ecosystems are improved.

Advantageously, the system is self-floating and does not require support from other materials (e.g., air-filled vessels) to stay above the waterline in some embodiments.

The disclosed system helps prevent the greenhouse effect through carbon sequestration, which involves the removal of carbon dioxide from the atmosphere and the conversion of carbon to biomass.

The system provides shelter and a habitat for wildlife, such as birds.

The presently disclosed subject matter also reduces evaporation of water 25, thereby preserving the water resources in arid environments. The disclosed system therefore can be used to reduce evaporation from bodies of water.

In some embodiments, the system is partially or fully biodegradable and/or compostable.

Advantageously, the disclosed system is designed to be aesthetically pleasing thereby adding to the attractiveness of the aquatic environment.

Installation of the disclosed system is seamless and does not require the draining of water, construction of a submerged substructure, fitting or alteration of a pond liner, or disturbance of existing flora or fauna.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A buoyant plant cultivation system, the system comprising:
a support comprising a flat nonwoven sheet constructed from a single layer of one or more buoyant materials, the support defined by a top face and an opposed bottom face, with an interior therebetween, and an outer surface on the top face;
a plurality of plant seeds positioned on the outer surface of the top face of the support;
wherein the plant seeds are configured to germinate and grow on the outer surface of the top face of the support such that plant roots extend into the interior of the support and plant leaves and plant stems grow above the outer surface of the top face of the support;
wherein the support is configured to float on a body of water.

2. The system of claim 1, wherein the support is constructed from kapok fibers, open-celled foam, cork, perlite, vermiculite, or combinations thereof.

3. The system of claim 2, wherein the support further includes one or more polymeric materials selected from polyethylene, polypropylene, or both.

4. The system of claim 1, wherein the support is permeable to air and water.

5. The system of claim 1, wherein the buoyant material is biodegradable.

6. The system of claim 1, wherein the support is about 100% biodegradable.

7. The system of claim 1, wherein the support has a length, width, or both of about 1-100 feet and a thickness of about 0.5-5 inches.

8. The system of claim 1, wherein the support is self-floating.

9. A method of reducing pollutants from a body of water that includes pollutants, the method comprising:
positioning the floating plant cultivation system of claim 1 into a body of water, wherein the support floats on a surface of the body of water, and wherein the water enters the interior of the support through capillary action;
germinating the seeds such that the seeds grow into plants with roots that extend into the interior of the support and plant leaves and stem grow above the outer surface of the top face of the support;
wherein as the plants grow, the plants absorb the pollutants from the water;
whereby the amount of pollutants in the body of water are reduced.

10. A method of reducing the amount of carbon dioxide in an environment, the method comprising:
positioning the floating plant cultivation system of claim 1 into a body of water, wherein the support floats on a surface of the body of water, and wherein the water enters the interior of the support through capillary action;
germinating the seeds such that the seeds grow into a plant with roots that extend into the interior of the support and plant leaves and stems grow above the outer surface of the top face of the support;
wherein as the plants grow, the plants absorb carbon dioxide from the environment and the amount of carbon dioxide is thereby reduced.

11. A method of reducing algal bloom in a body of water, the method comprising:
positioning the floating plant cultivation system of claim 1 into a body of water, wherein the support floats on a surface of the body of water, and wherein the water enters the interior of the support through capillary action;
germinating the seeds such that the seeds grow into a plant with roots that extend into the interior of the support and plant leaves and stems grow above the outer surface of the top face of the support;
wherein as the plants grow, the plants absorb nutrients from the body of water and the amount of nutrients within the body of water is thereby reduced and algal bloom is reduced.

12. A plant cultivation system, the system comprising:
a support configured as a sheet constructed from a single layer of one or more buoyant polymeric materials, the support defined by a top face and an opposed bottom face, with an interior therebetween, and an outer surface on the top face;
a plurality of plant seeds positioned on the outer surface of the top face of the support;
wherein the plant seeds are configured to germinate and grow such that plant roots extend into an interior of the support and plant leaves and plant stems grow above the outer surface of the top face of the support;
wherein the support is configured to float on a body of water for a predetermined amount of time, and then sinks to a bottom of the body of water.

13. The system of claim 12, wherein the support floats with the current or is anchored at a predetermined location.

14. The system of claim 12, wherein the polymeric materials are selected from polyethylene, polypropylene, or combinations thereof.

15. The system of claim 12, wherein the predetermined amount of time is about 1-4 months.

16. A carbon sequestration system comprising:
a non-buoyant support constructed from one or more non-biodegradable polymeric materials;
one or more floatation devices configured to float on a surface of a body of water, each floatation device attached to the non-buoyant support positioned beneath the surface of the body of water;
wherein the support is positioned about 10-30 feet below the surface of the body of water.

17. The carbon sequestration system of claim 16, further comprising a plurality of aquatic plants positioned on a top face or within an interior of the support, wherein the aquatic plants are configured to grow on and within the support.

18. The carbon sequestration system of claim 17, wherein the aquatic plants are selected from sea grasses, seaweed, kelp, or combinations thereof.

19. The carbon sequestration system of claim 16, wherein the support has a density that is greater than the density of the body of water.

20. A method of sequestering carbon from an environment, the method comprising:
positioning the carbon sequestration system of claim 16 into the body of water, wherein the support sinks beneath a surface of the water and the one or more floatation devices float on the water and retain the support a desired depth within the water;
positioning aquatic plants within the interior of the support, on the surface of the support or both;
wherein as the plants grow, the plants absorb carbon dioxide from the body of water and the carbon is thereby sequestered from the environment.
